(19) United States
(12) Patent Application Publication
(10) Pub. No.: US 2021/0078876 A1
(43) Pub. Date: Mar. 18, 2021

(54) STREAMLINED ELECTROCHEMICAL ADVANCED OXIDATION PROCESS FOR POTABLE WATER REUSE

(71) Applicant: THE BOARD OF TRUSTEES OF THE LELAND STANFORD JUNIOR UNIVERSITY, Stanford, CA (US)

(72) Inventor: William Mitch, Stanford, CA (US)

(73) Assignee: THE BOARD OF TRUSTEES OF THE LELAND STANFORD JUNIOR UNIVERSITY, Stanford, CA (US)

(21) Appl. No.: 17/023,154

(22) Filed: Sep. 16, 2020

Related U.S. Application Data
(60) Provisional application No. 62/901,655, filed on Sep. 17, 2019.

(51) Int. Cl. C02F 1/461; C02F 9/00; C02F 1/44

(52) U.S. Cl. CPC C02F 1/4618; C02F 2001/46185; C02F 1/441; C02F 9/005

(57) ABSTRACT

Example implementations include a method of degrading a reactant including contacting a nonacidic solution and an anode coupled to a voltage source, contacting an acidic solution including an organic reactant and a cathode coupled to the voltage source, applying a voltage across the cathode and the anode, generating hydroxyl radical in the solution in response to the applying the voltage, and degrading the organic reactant by contact with the hydroxyl radical. Example implementations also include a device for degrading a reactant, including a first fluid chamber including a first stainless steel conductor and configured to contact a nonacidic solution, a second fluid chamber including a second stainless steel conductor and configured to contact an acidic solution, a cation-exchange membrane coupling the first fluid chamber and the second fluid chamber, and a voltage source operatively coupling the first stainless steel conductor and the second stainless steel conductor, and configured to apply a voltage across the first stainless steel conductor and the second stainless steel conductor, to generate hydroxyl radical in the solution in response to the applying the voltage, and to degrade the organic reactant by contact with the hydroxyl radical.

### CROSS-REFERENCE TO RELATED PATENT APPLICATIONS

This application claims priority to U.S. Provisional Patent Application Ser. No. 62/901,655, entitled “Streamlined Electrochemical Advanced Oxidation Process for Potable Water Reuse,” filed Sep. 17, 2019, the contents of such application being hereby incorporated by reference in its entirety and for all purposes as if completely and fully set forth herein.

### TECHNICAL FIELD

The present implementations relate generally to water purification, and more particularly to an electrochemical oxidation process for potable water reuse.

### BACKGROUND

The increasing volume of populations served by municipal and centralized water systems drives demand for efficient and effective water treatment and purification at scale. Conventional systems regularly rely on systems involving expensive or cumbersome purification materiel, including but not limited to ferrous solutes for degrading biochemical contaminants. However, conventional systems may not effectively degrade biochemical contaminants with system less reliant on complex reagents. Thus, a technological solution for generating an electrochemical oxidation reagent and associated permeate for potable water reuse is desired.

### SUMMARY

Example implementations include a method of degrading a reactant including contacting a nonacidic solution and an anode coupled to a voltage source, contacting an acidic solution including an organic reactant and a cathode coupled to the voltage source, applying a voltage across the cathode and the anode, generating hydroxyl radical in the solution in response to the applying the voltage, and degrading the organic reactant by contact with the hydroxyl radical.

Example implementations also include a device for degrading a reactant, including a first fluid chamber including a first stainless steel conductor and configured to contact a nonacidic solution, a second fluid chamber including a second stainless steel conductor and configured to contact an acidic solution, a cation-exchange membrane coupling the first fluid chamber and the second fluid chamber, and a voltage source operatively coupling the first stainless steel conductor and the second stainless steel conductor, and configured to apply a voltage across the first stainless steel conductor and the second stainless steel conductor, to generate hydroxyl radical in the solution in response to the applying the voltage, and to degrade the organic reactant by contact with the hydroxyl radical.

Example implementations also include a system for degrading a reactant, including a first fluid chamber including a first stainless steel conductor and configured to contact a nonacidic solution, a second fluid chamber including a second stainless steel conductor and configured to contact an acidic solution, a cation-exchange membrane coupling the first fluid chamber and the second fluid chamber, and a voltage source operatively coupling the first stainless steel conductor and the second stainless steel conductor, and configured to apply a voltage across the first stainless steel conductor and the second stainless steel conductor, to generate hydroxyl radical in the solution in response to the applying the voltage, and to degrade the organic reactant by contact with the hydroxyl radical.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates an example system in accordance with present implementations.

FIG. 2 illustrates an example reagent generator in accordance with present implementations.

FIG. 3 illustrates an example reagent source generator in accordance with present implementations.

FIG. 4 illustrates an example method of generating a reagent source in accordance with present implementations.

FIG. 5 illustrates an example method of preparing a permeate further to the example method of FIG. 4.

FIG. 6 illustrates an example method of degrading a reactant further to the example method of FIG. 5.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

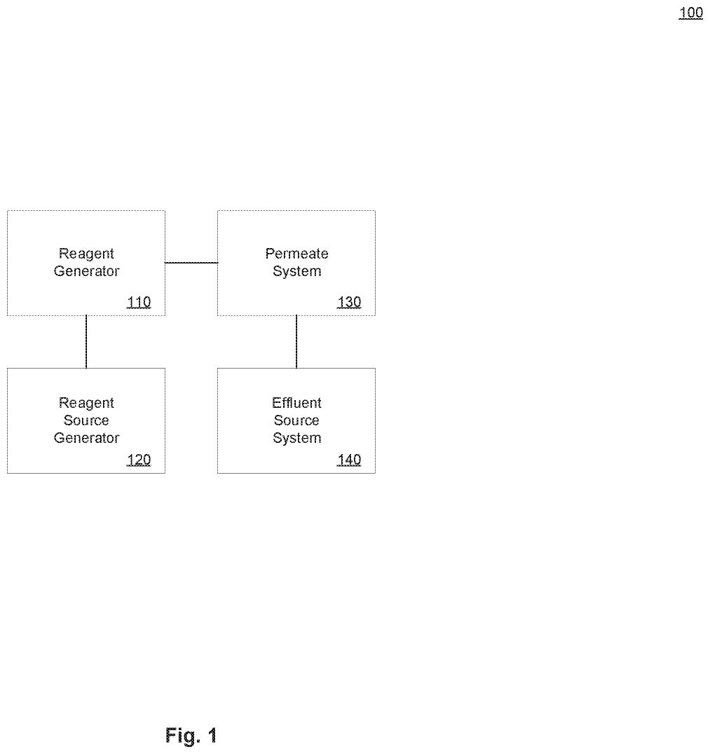

FIG. 1 illustrates an example system in accordance with present implementations. As illustrated by way of example in FIG. 1, an example system 100 includes a reagent generator 110, a reagent source generator 120, a permeate system 130, and an effluent source system 140.

The reagent generator 110 is operable to conduct one or more chemical, electrochemical, or like processes therein. In some implementations, the reagent generator 110 includes multiple fluid chambers and at least one electrical device operable to conduct electrolysis, an electrochemical process, or the like. In some implementations, the reagent generator 110 is operable to generate one or more ionized or electrically-neutral molecules through electrolysis of one or more fluids therein. In some implementations, the reagent generator 110 is operable to collect ionized or electrically-neutral molecules generated therein or therewith. In some implementations, the reagent generator 110 is operable to controllably apply voltage to one or more electrical, conductive, or like components thereof or therewith. In some implementations, the reagent generator 110 is coupled to the reagent source generator 120, to receive one or more electrolytes, fluids, solutions, or the like thereto or therewith. In some implementations, the reagent generator 110 is coupled to the permeate system 130 to provide one or more fluids, chemicals, biochemical thereto or therewith.

The reagent source generator 120 is operable to generate one or more electrolytes, fluids, solutions, and the like. In some implementations, the reagent source generator 120 includes one or more fluids, liquids, solutions, powders, dispersions, and the like. In some implementations, the reagent source generator 120 is operable to generate one or more fluids, liquids, and the like having one or more particular concentrations of dissolved solids. In some implementations, the reagent source generator 120 is operable to generate one or more fluids, liquids, and the like having one or more particular concentrations of liquids or fluids. In some implementations, the reagent source generator 120 is operable to generate one or more fluids, liquids, and the like having one or more particular concentrations resulting in one or more particular pH levels. In some implementations, the reagent source generator 120 is coupled to the reagent generator 110 by one or more supply tubes, pipes, or the like, to supply one or more of the generated fluids, liquids, and the like, to the reagent generator 110. In some implementations, the reagent source generator includes one or more electronic, electrical, electrochemical, electromechanical, mechanical, chemical, or like devices to control mixing of and transfer of various reagent source material and combinations thereof.

The permeate system 130 is operable to at least partially degrade contamination of fluid received from the effluent source system. In some implementations, the permeate system 130 includes one or more permeates disposed between an input supply tube, pipe, or the like, to the permeate system, and an output supply tube, pipe, or the like thereof. In some implementations, the permeate of the permeate system includes a filtration sheet, plane, layer, or the like. In some implementations, the permeate is electrically charged to allow certain ions to pass through, to block certain ions from passing therethrough, or a combination thereof. As one example, the permeate system may be ionically charged to discourage transmission of hydroxide radicals or hydroxide ions from passing across the permeate. In some implementations, the permeate is operable to block passage of solid objects greater than a particular size, and to allow smaller particles to pass through for chemically, biochemically, electrochemically, or like treatment. In some implementations, the permeate system includes multiple chambers and multiple stages. In some implementations, one or more first stages of filtering particles through one or more permeates are followed by one or more second stages of chemical, biochemical, electrochemical treatment. In some implementations, the reactant generator 110 provides catalyst, reactant, or the like to the permeate system 130 to effect the second stages. In some implementations, the permeate system 130 includes one or more contaminant output tubes, pipes, or the like for expelling concentrated contaminants captures by the permeate or permeates. In some implementations, the permeate system 130 includes one or more treated output tubes, pipes, or the like for expelling treated, decontaminated, or less contaminated water, fluid, or the like.

The effluent source system 140 is operable to provide at least one fluid for decontamination to at least one of the reagent generator 110 and the permeate system 130. In some implementations, the effluent source system 140 includes, is coupled to, or is an integrable portion of, wastewater from municipal water sources or treatment plants.

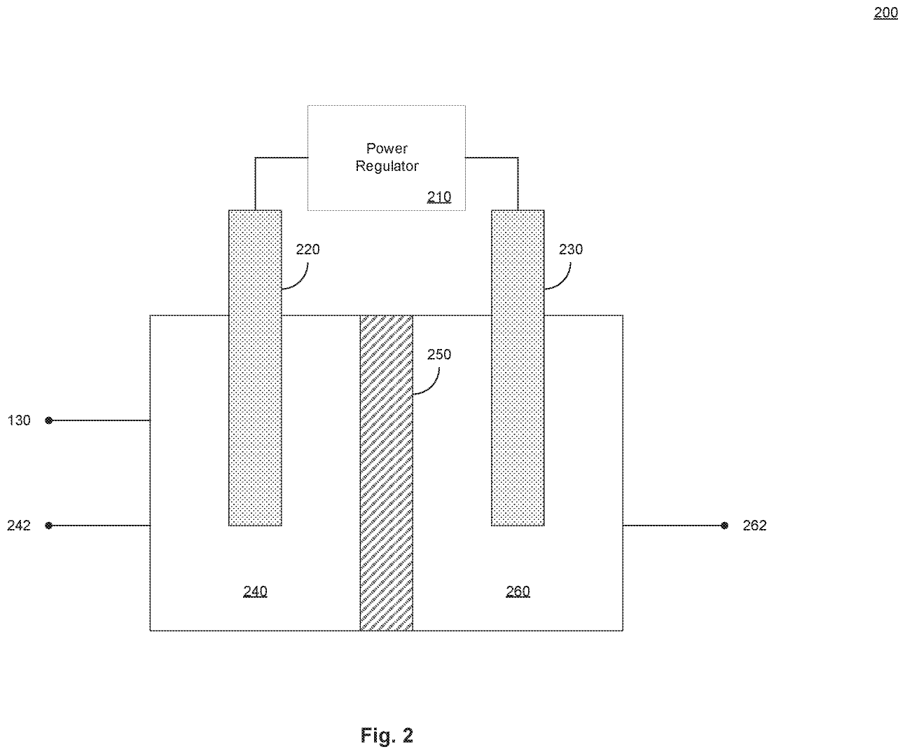

FIG. 2 illustrates an example reagent generator in accordance with present implementations. As illustrated by way of example in FIG. 2, an example reagent generator 200 includes a power regulator 210, a cathode 220, an anode 230, a cathode chamber 240, a cathode chamber fluid path 242, an ion exchange membrane 250, an anode chamber 260, and an anode chamber fluid path 262. In some implementations, the reagent generator 110 includes the example reagent generator 200.

The power regulator 210 is operable to generate and supply electrical power to the example reagent generator 200. In some implementations, the power regulator includes one or more of voltage source and a current source operable to generate at least one of a DC voltage potential and a DC current. In some implementations, the power regulator is operable to generate one or more periodic, cyclic, alternating, or like voltage or current signals. In some implementations, periodic, cyclic, alternating, or like voltage or current signals include a step-voltage signal including a high ‘on’ portion alternating with a low ‘off’ portion. In some implementations, a high ‘on’ state includes a positive voltage applied to the cathode 220 and a ground voltage applied to the anode 230. In some implementations, a low ‘off’ state includes a ground voltage applied to the cathode 220 and to the anode 230. In some implementations, the power regulator 210 generates one of more voltage potentials grounded at, calibrated to, or the like, a standard hydrogen electrode SHE.

The cathode 220 and the anode 230 are each conductors operable to receive electrical power from the power regulator 210. In some implementations, at least one of the cathode 220 and the anode 230 includes, or contain primarily, stainless steel. In some implementations, at least one of the cathode 220 and the anode 230 is a stainless steel, mesh, plane, rod, or the like, or a combination thereof. In some implementations, a ratio between surface area of the cathode 220 and volume of the cathode chamber 240 impacts a rate at which the example reagent generator 200. In some implementations, a higher surface area of the cathode 220 and the anode 230 to volume of the cathode chamber 240 and anode chamber 260, respectively, increases rate of generation of reagent through electrolysis. In some implementations, the higher rate of generation of reagent in the presence of reactant, in turn, increases a rate of degradation of reactant. In some implementations, reagent includes hydroxyl radical (*OH). In some implementations, reactant includes 1,4-dioxane, p-dioxane, or the like. In some implementations, at least one of the cathode 220 and the anode 230 has a ratio of surface area to volume of 3.3 cm²/cm³.

The cathode chamber 240 is operable to hold a liquid, solution, or the like, contactably with the cathode 220. In some implementations, the cathode chamber 240 is a glass chamber, watertight chamber, airtight chamber, or the like. In some implementations, the cathode chamber 240 is or includes an electrically insulating material, including but not limited to glass. In some implementations, the cathode chamber 240 is coupled to the reagent source generator 120 to receive reagent source therefrom by the cathode chamber supply path 242. In some implementations, the cathode chamber supply path 242 is a passive, actively pumped, or the like, connection between the cathode chamber 240 and the reagent source generator 120. In some implementations, the cathode chamber 240 is coupled to the permeate system 130 to provide reagent thereto. In some implementations, the cathode chamber 240 generates hydroxyl radical *OH and transmits, pumps, or the like, the hydroxyl radical to at least one or more second stages of the permeate system 130. The ion exchange membrane 250 is operable to selectively transmit ions between and within the cathode chamber 240 and the anode chamber 260. In some implementations, the ion exchange membrane is or includes a cation exchange membrane.

The anode chamber 260 is operable to hold a liquid, solution, or the like, contactably with the anode 230. In some implementations, the anode chamber 260 is a glass chamber, watertight chamber, airtight chamber, or the like. In some implementations, the anode chamber 260 is or includes an electrically insulating material, including but not limited to glass. In some implementations, the anode chamber 260 is coupled to the reagent source generator 120 to receive reagent source therefrom by the anode chamber supply path 262. In some implementations, the anode chamber supply path 262 is a passive, actively pumped, or the like, connection between the anode chamber 260 and the reagent source generator 120.

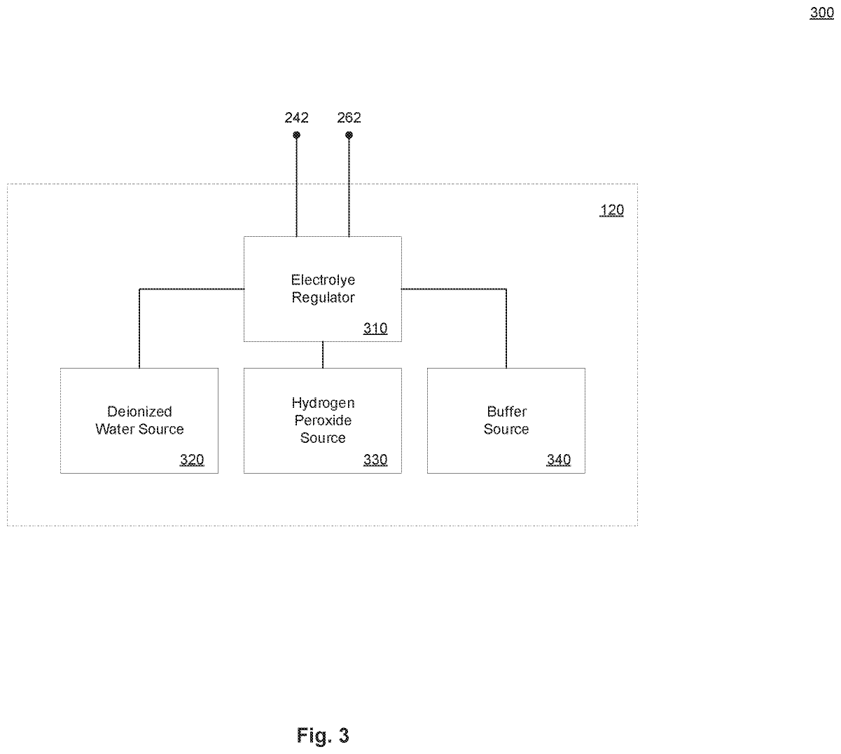

FIG. 3 illustrates an example reagent source generator in accordance with present implementations. As illustrated by way of example in FIG. 3, an example reagent source generator 300 includes an electrolyte regulator 310, a deionized water source 320, a hydrogen peroxide source 330, and a buffer source 340. In some implementations, the reagent source generator 120 includes the example reagent source generator 300.

The electrolyte regulator 310 is operable to generate one or more liquids, solutions, or the like having one or more fluid composition characteristics. In some implementations, the electrolyte regulator 310 includes one or more electronic, electrical, electrochemical, electromechanical, mechanical, chemical, or like devices to control mixing of and transfer of various reagent source material and combinations thereof. In some implementations, the electrolyte regulator 310 includes one or more logical gates, devices, integrated circuits, analog sensors, or the like, operable to generate and maintain one or more solutions with one or more particular composition characteristics. In some implementations, composition characteristics include molar concentration of dissolved solids or liquids, pH level, and the like. In some implementations, the electrolyte regulator is operable to generate a cathode solution associated with the cathode chamber 240. In some implementations, the electrolyte regulator is operable to generate a cathode solution transferable to the cathode chamber 240 by the cathode chamber supply path 242. In some implementations, the electrolyte regulator is operable to generate an anode solution associated with the anode chamber 260. In some implementations, the electrolyte regulator is operable to generate an anode solution transferable to the anode chamber 260 by the anode chamber supply path 262. In some implementations, the electrolyte generator is operable to concurrently generate the cathode solution and the anode solution. In some implementations, the electrolyte regulator 310 combines at least a subset of components before transfer to at least one of the cathode chamber 240 and the anode chamber 260. Alternatively, in some implementations, the electrolyte regulator 310 combines at least a subset of components before transfer to at least one of the cathode chamber 240 and the anode chamber 260.

The deionized water source 320 includes deionized water available as a solvent for electrolysis or like processes of the reagent generator 110. In some implementations, the deionized water source 320 includes a reserve tank or pumped supply of deionized water. The hydrogen peroxide source 330 includes hydrogen peroxide available as a solute for addition to the deionized water. In some implementations, the hydrogen peroxide source 320 includes a reserve tank or pumped supply of hydrogen peroxide. The buffer source 340 include a pH buffer material available as a solute for addition to the deionized water. In some implementations, the buffer source 320 includes a reserve tank or pumped supply of buffer. In some implementations, the buffer is or include potassium or the like in powder or dissolvable form.

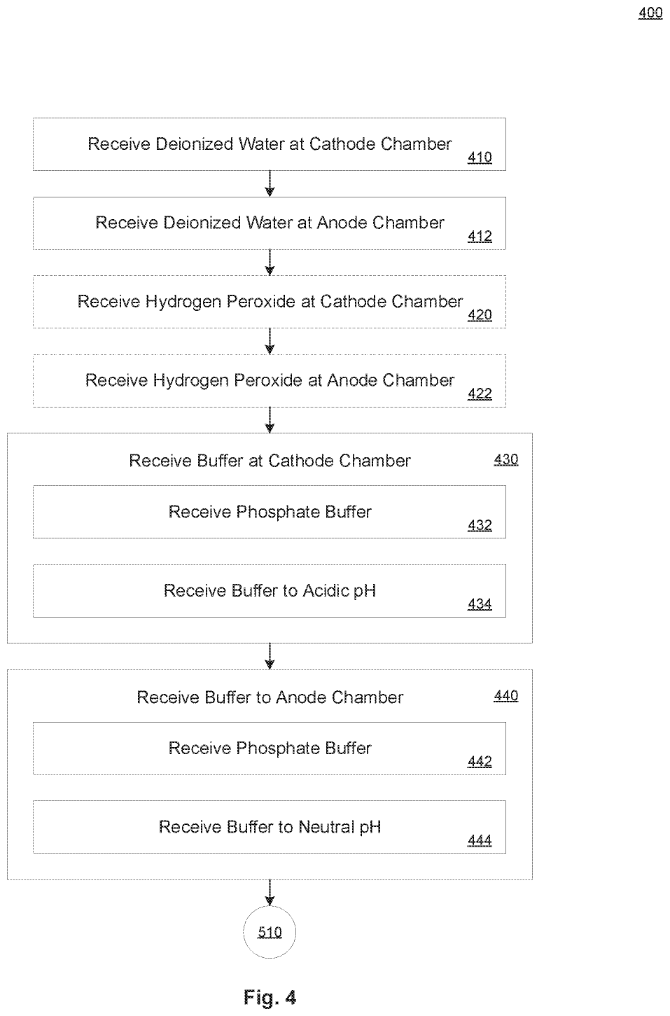

FIG. 4 illustrates an example method of generating a reagent source in accordance with present implementations. In some implementations, at least one of the example system 100, the example reagent generator 200, and the example reagent source generator 300 performs method 400 according to present implementations. In some implementations, the method 400 begins at step 410.

At step 410, an example system receives deionized water at a cathode chamber of the example system. In some implementations, the cathode chamber 240 receives deionized water from the deionized water source 320. In some implementations, the electrolyte regulator 310 transfers the deionized water to the cathode chamber 240. It is to be understood that the example system can transfer the deionized water to the cathode chamber 240 prior to, concurrently with, or subsequently to the addition of any solute or other material thereto. The method 400 then continues to step 412. At step 412, the example system receives deionized water at an anode chamber of the example system. In some implementations, the anode chamber 260 receives deionized water from the deionized water source 320. In some implementations, the electrolyte regulator 310 transfers the deionized water to the anode chamber 260. It is to be understood that the example system can transfer the deionized water to the anode chamber 260 prior to, concurrently with, or subsequently to the addition of any solute or other material thereto. The method 400 then continues to step 420.

At step 420, the example system receives hydrogen peroxide at the cathode chamber. In some implementations, the cathode chamber 240 receives hydrogen peroxide from the hydrogen peroxide source 330. In some implementations, the electrolyte regulator 310 transfers the hydrogen peroxide to the cathode chamber 240. In some implementations, the example system receives hydrogen peroxide at a concentration between 0.5 mg/L and 1.25 mg/L. In some implementations, a hydrogen peroxide concentration between 0.5 mg/L and 1.25 mg/L results in hydrogen peroxide decay of 75-80% over 240 seconds. In some implementations, at higher concentrations, percentage degradation declines to approximately 20% over 240 seconds. Thus, in some implementations, a hydrogen peroxide concentration between 0.5 mg/L and 1.25 mg/L results in a high degradation percentage of hydrogen peroxide, which, in turn supports faster biochemical reactant degradation and faster water purification. It is to be understood that the example system can transfer the hydrogen peroxide to the cathode chamber 240 prior to, concurrently with, or subsequently to the addition of any other solute or other material to the deionized water. The method 400 then continues to step 422. At step 422, the example system receives hydrogen peroxide at the anode chamber. In some implementations, the example system receives hydrogen peroxide at the anode chamber 260 correspondingly to receiving hydrogen peroxide at the cathode chamber 240. The method 400 then continues to step 430.

At step 430, the example system receives buffer at the cathode chamber. In some implementations, the cathode chamber 240 receives buffer from the buffer source 340. In some implementations, the electrolyte regulator 310 transfers buffer to the cathode chamber 240. It is to be understood that the example system can transfer buffer to the cathode chamber 240 prior to, concurrently with, or subsequently to the addition of any solute or other material to the deionized water. In some implementations, step 430 includes at least one of steps 432 and 434. At step 432, the example system receives phosphate buffer at the cathode chamber. In some implementations, the cathode chamber 240 receives phosphate buffer at a concentration of 2 mM in deionized water. At step 434, the example system receives buffer to obtain an acidic pH. In some implementations, the cathode chamber 240 receives buffer to achieve an acidic pH between 5.6 and 6.7. In some implementations, degradation of hydrogen peroxide after 300 seconds of treatment is approximately 65% at pH 5.8, approximately 51% at pH 6.1, and approximately 40% at pH between 6.4 and 7.0. Concurrently, in some implementations, degradation of 1,4-dioxane is approximately 63% at pH 5.8 and pH 6.1, and approximately 45% at pH 6.4. In some implementations, at pH 6.7 and 7.0, degradation of 1,4-dioxane is less than 24%, approximately corresponding to the decrease observed in the absence of hydrogen peroxide at pH 7.0. Thus, in some implementations, a more acidic cathode chamber solution promotes higher degradation of dioxane and like contaminants. The method 400 then continues to step 440.

At step 440, the example system receives buffer at the anode chamber. In some implementations, the anode chamber 260 receives buffer from the buffer source 340. In some implementations, the electrolyte regulator 310 transfers buffer to the anode chamber 260. It is to be understood that the example system can transfer buffer to the anode chamber 260 prior to, concurrently with, or subsequently to the addition of any solute or other material to the deionized water. In some implementations, step 440 includes at least one of steps 442 and 444. At step 442, the example system receives phosphate buffer at the cathode chamber. In some implementations, the anode chamber 260 receives phosphate buffer at a concentration of 2 mM in deionized water. At step 444, the example system receives buffer to obtain a neutral pH. In some implementations, the cathode chamber 240 receives buffer to achieve an acidic pH of approximately 7.0. In some implementations, the method 400 then continues to step 510.

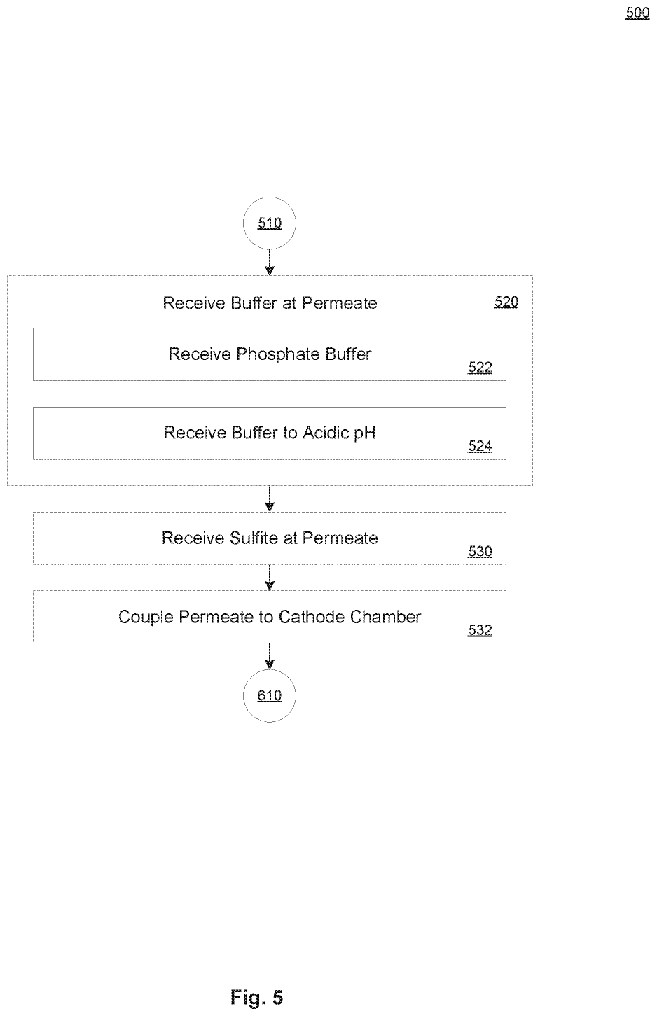

FIG. 5 illustrates an example method of preparing a permeate further to the example method of FIG. 4. In some implementations, at least one of the example system 100, the example reagent generator 200, and the example reagent source generator 300 performs method 400 according to present implementations. In some implementations, the method 500 begins at step 510. The method 500 then continues to step 520.

At step 520, the example system receives buffer at a permeate of the example system. In some implementations, the permeate is or includes a reverse osmosis (RO) permeate capable of inhibiting passage of various particulate matter therethrough, while allowing passage of water therethrough. In some implementations, the example system receives a buffered RO permeate. In some implementations, the RO permeate receives buffer at a concentration of at least 2 mM. A concentration of 2 mM or greater drives a significantly increase degradation rate of hydrogen peroxide and dioxane reactant and the like. In some implementations, an RO permeate is treated with electrolysis in accordance with an electrolysis process associated with the cathode chamber 240. In some implementations, the RO permeate is treated with an electrolysis process within the cathode chamber 240. In some implementations, step 520 includes at least one of steps 522 and 524. At step 522, the example system receives phosphate buffer at the permeate. At step 524, the example system receives buffer to obtain an acidic pH. In some implementations, a concentration of phosphate or like buffer associated with the buffered RO permeate creates or approximately creates a pH of 5.48. It is to be understood that the RO permeate can be buffered to any level matching a pH level of the liquid, solution, or the like received at the cathode chamber 240. The method 500 then continues to step 530.

At step 530, the example system receives sulfite at the permeate. In some implementations, buffered RO permeate includes a scavenging effect attributable to chloramines and carbonates associated therewith. As one example, a scavenging effect reduces a degradation rate associated with the example system, by reacting with the reagent. Thus, in some implementations, sulfite is added to the RO permeate to reduce reagent interaction with chloramines increased rate of degradation of 1,4-dioxane from 30% to 40% over an example 300-second period. The method 500 then continues to step 532. At step 532, the example system couples the permeate to the cathode chamber of the example system. In some implementations, the permeate is in contact with the solution generated at the cathode chamber 240. In some implementations, the permeate is in contact with the solution generated at the cathode chamber 240 and within the cathode chamber 240. In some implementations, the method 500 then continues to step 610.

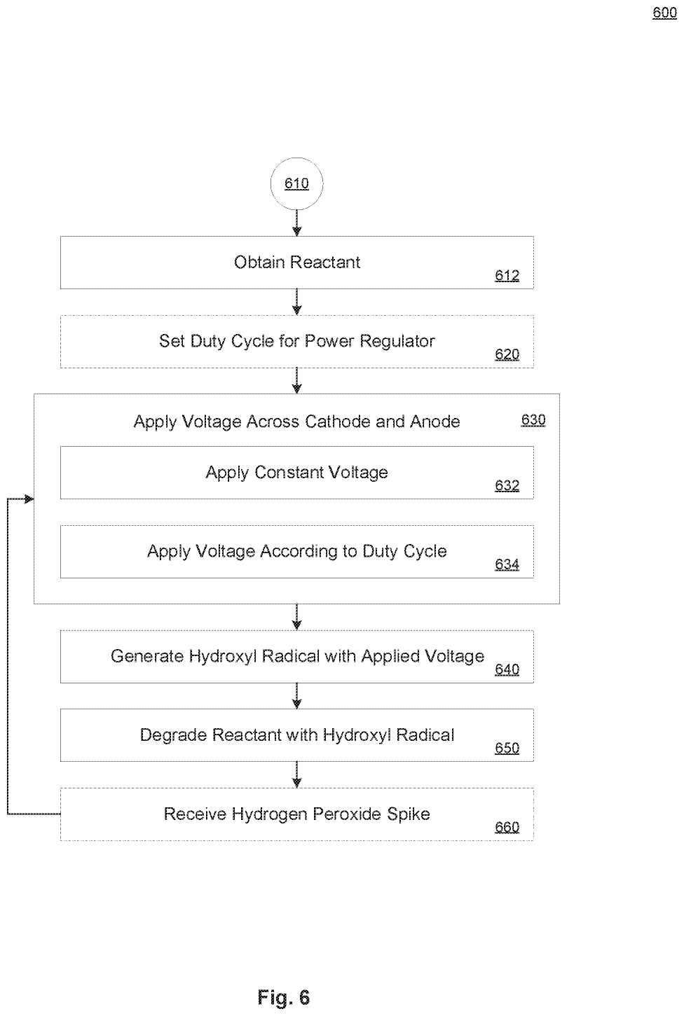

FIG. 6 illustrates an example method of degrading a reactant further to the example method of FIG. 5. In some implementations, at least one of the example system 100, the example reagent generator 200 and the example reagent source generator 300 performs method 400 according to present implementations. In some implementations, the method 600 begins at step 610. The method 600 then continues to step 612.

At step 612, the example system obtains a reactant. Dioxane, including but not limited to 1,4-dioxane, possess properties similar to organic compounds common in wastewater. Thus, in some implementations, the effect of degradation on dioxane is an effective determinant of the effect of degradation in a wide range of water treatment and purification scenarios. While 1,4-dioxane features neutral charge over a broad ranges of pH, it is to be understood that the example system is not limited to treatment of dioxane and like molecular structures. In some implementations, the example system is operable to degrade charged particles. As one example, the example system can degrade cyclohexylamine (pKa=10.6) and cyclohexanecarboxylic acid (pKa=4.9), given the dominances of the positively charged cyclohexylammonium and the negatively charged cyclohexanecarboxylate at pH 5.8. An another example, the example system can degrade positively charged cyclohexylammonium at approximately 90% over 450 seconds. As another example, the example system can degrade 1,4-dioxane at approximately 60% over 450 seconds. As another example, the example system can degrade negatively charged cyclohexanecarboxylate at approximately 80% over 450 seconds. The method 600 then continues to step 620.

At step 620, the example system sets a duty cycle for a power regulator of the example system. In some implementations, the power regulator 210 automatically sets a duty cycle. Alternatively, in some implementations, the power regulator 210 receives a duty cycle setting from an external device, system, user, or combination thereof. The method 600 then continues to step 630. At step 630, the example system applies voltage across a cathode and an anode of the example system. In some implementations, the power regulator 210 applied the voltage across the cathode 220 and the anode 230. In some implementations, step 630 includes at least one of steps 632 and 634. At step 632, the example system applies a constant voltage. In some implementations, the constant voltage is a DC voltage between −0.8 V to +0.4 from SHE, ground, or the like. In some implementations, the power regulator applies the voltage potential to the cathode 220 and the SHE, ground, or like voltage to the anode 230. At step 634, the example system applies voltage according to the set duty cycle. In some implementations, the example system applies a potential of −0.3 V from SHE to the cathode 220 for 30 seconds, followed by an off period with a potential of 0V from SHE for 30 seconds. In some implementations, the cathode chamber 240 is buffered at pH 5.6 and the anode chamber 260 is buffered at pH 7.0, both with 10 mM phosphate buffer, during the duty cycle voltage application. In some implementations, the example system applies an alternating current of −0.3 V from S.H.E. to the cathode 220 for up to 100 seconds, followed by an off period with a potential of 0V from SHE, for 30 seconds. In some implementations, this pattern is repeated multiple times and concludes with one final off period of 100 seconds. As one example, the example system can generate three 100-second ‘on’ periods alternating with three 30-second ‘off’ periods and concluding with one 100-second ‘off’ period, for a total duty cycle operation of 490 seconds. The results indicated 0.57-log removal of 1,4-dioxane, even without the addition of H₂O₂ (FIG. 2). This is significant because the removal of 1,4-dioxane in RO permeate did not require any addition of hydrogen peroxide. It is to be understood that voltages and time periods for the duty cycle operation can vary from the examples set forth herein. The method 600 then continues to step 640.

At step 640, the example system generates hydroxyl radical in response to the applied voltage. In some implementation, reduction of H₂O₂ can proceed by either a one electron transfer pathway to produce *OH or a two electron transfer pathway to produce water. In some implementations, the example system degrades 1,4-dioxane at a lower rate compared to hydrogen peroxide with increasing pH, where the two electron pathway becomes increasingly favored over the one electron pathway as the pH increases. In some implementations, higher pH favors hydrogen peroxide reduction by the two electron pathway, thereby reducing 1,4-dioxane degradation while maintaining hydrogen peroxide degradation. Thus, in some implementations, it is advantageous to maintain lower pH in the cathode chamber to favor degradation of reactant over hydrogen peroxide. The method 600 then continues to step 650.

At step 650, the example system degrades the reactant at least partially with the hydroxyl radical. In some implementations, dioxane degradation increases with a combination of higher hydrogen peroxide concentrations and lower potentials applied to the cathode relative to pH 5.8. As one example, hydrogen peroxide can range between 1.25-2.5 mg/L and voltage potentials at the cathode 220 can be −0.3 V from SHE. Total amount of dioxane removal can be inversely proportion in these scenarios. As one example, maximum removal of 1,4-dioxane after 450 seconds of treatment can be 31%. The method 600 then continues to step 660.

At step 660, the example system receives a hydrogen peroxide spike. In some implementations, hydrogen peroxide is added to the example system gradually, periodically, repeated, cyclically, or the like. In some implementations, the electrolyte regulator 310 adds hydrogen peroxide to the cathode chamber 240 from the hydrogen peroxide source 330. In some implementations, sequential spiking of hydrogen peroxide is conducted at approximately pH 5.5 at the cathode chamber 240. In some implementations, hydrogen peroxide can be added once to achieve a concentration of 1.25 mg/L, or twice at a concentration of 0.6 mg/L. In some implementations, sequential spiking can occur concurrently with one or more duty cycle transitions of the power regulator 210. In some implementations, the method 600 ends at step 660.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A method of degrading a reactant, the method comprising:
contacting a nonacidic solution and an anode coupled to a voltage source;
contacting an acidic solution including an organic reactant and a cathode coupled to the voltage source;
applying a voltage across the cathode and the anode;
generating hydroxyl radical in the solution in response to the applying the voltage; and
degrading the organic reactant by contact with the hydroxyl radical.

2. The method of claim 1, wherein the acidic solution includes deionized water and a phosphate buffer at a concentration of at least 2 mM.

3. The method of claim 2, wherein the acidic solution further includes hydrogen peroxide at a concentration of at least 0.5 mg/L.

4. The method of claim 1, wherein the nonacidic solution includes deionized water and a phosphate buffer at a concentration of at least 2 mM.

5. The method of claim 1, wherein the nonacidic solution has a substantially neutral pH.

6. The method of claim 1, wherein the applying the voltage further comprises applying a constant direct current voltage across the cathode and the anode.

7. The method of claim 1, wherein the applying the voltage further comprises applying an alternating direct current voltage across the cathode and the anode.

8. The method of claim 1, further comprising:
wherein the applying the alternating direct current further comprises applying the alternating direct current voltage across the cathode and the anode in accordance with a duty cycle parameter.

9. The method of claim 1, further comprising:
contacting the acidic solution and a reverse osmosis permeate,
wherein the degrading the organic reactant further comprises chemically degrading the organic reactant by contact with the hydroxyl radical.

10. The method of claim 8, further comprising:
buffering the reverse osmosis permeate with a buffer at a concentration of at least 2 mM.

11. The method of claim 9, wherein the buffer comprises a phosphate buffer.

12. The method of claim 8, further comprising:
buffering the reverse osmosis permeate to an acidic pH.

13. The method of claim 8, further comprising:
contacting the reverse osmosis permeate and a sulfite,
wherein the degrading the organic reactant by contact with the hydroxyl radical occurs subsequently to the contacting the reverse osmosis permeate and the sulfite.

14. A device for degrading a reactant, the device comprising:
a first fluid chamber including a first stainless steel conductor and configured to contact a nonacidic solution;
a second fluid chamber including a second stainless steel conductor and configured to contact an acidic solution;
a cation-exchange membrane coupling the first fluid chamber and the second fluid chamber; and
a voltage source operatively coupling the first stainless steel conductor and the second stainless steel conductor, and configured to apply a voltage across the first stainless steel conductor and the second stainless steel conductor, to generate hydroxyl radical in the solution in response to the applying the voltage, and to degrade the organic reactant by contact with the hydroxyl radical.

15. The device of claim 14, wherein the acidic solution includes deionized water and a phosphate buffer at a concentration of at least 2 mM.

16. The device of claim 14, wherein the acidic solution further includes hydrogen peroxide at a concentration of at least 0.5 mg/L.

17. The device of claim 14, wherein the nonacidic solution includes deionized water and a phosphate buffer at a concentration of at least 2 mM.

18. The device of claim 14, wherein the voltage source is further operable to apply a constant direct current voltage across the cathode and the anode.

19. The device of claim 14, wherein the voltage source is further operable to apply an alternating direct current voltage across the cathode and the anode.

20. A system for degrading a reactant, the system comprising:
a first fluid chamber including a first stainless steel conductor and configured to contact a nonacidic solution;
a second fluid chamber including a second stainless steel conductor and configured to contact an acidic solution;
a cation-exchange membrane coupling the first fluid chamber and the second fluid chamber; and
a voltage source operatively coupling the first stainless steel conductor and the second stainless steel conductor, and configured to apply a voltage across the first stainless steel conductor and the second stainless steel conductor, to generate hydroxyl radical in the solution in response to the applying the voltage, and to degrade the organic reactant by contact with the hydroxyl radical.
